(19) United States
(12) Patent Application Publication
(10) Pub. No.: US 2008/0196910 A1
(43) Pub. Date: Aug. 21, 2008

(54) ELECTRICAL SENSING DEVICE MODULES FOR ATTACHMENT TO POWER TOOLS AND DRILLS

(76) Inventors: Patrick J. Radle, Mequon, WI (US); Daryl C. Brockman, Shorewood, WI (US); David L. Wiesemann, Pewaukee, WI (US); George R. Steber, Mequon, WI (US); Thomas M. Luebke, Menomonee Falls, WI (US)

Correspondence Address: QUARLES & BRADY LLP, 411 E. WISCONSIN AVENUE, SUITE 2040, MILWAUKEE, WI, 53202-4497, US

(21) Appl. No.: 12/022,471

(22) Filed: Jan. 30, 2008

Related U.S. Application Data
(63) Continuation-in-part of application No. 11/179,969, filed on Jul. 12, 2005.
Application No. 11/179,969 is a continuation of application No. 09/884,518, filed on Jun. 19, 2001, now Pat. No. 6,926,473.
Application No. 09/884,518 is a continuation-in-part of application No. PCT/US07/73892, filed on Jul. 19, 2007.
Application No. PCT/US07/73892 is a continuation of application No. 11/458,596, filed on Jul. 19, 2006.
Application No. 11/458,596 is a continuation-in-part of application No. 11/005,187, filed on Dec. 6, 2004, now Pat. No. 7,295,130.
Application No. 11/005,187 is a continuation-in-part of application No. 10/808,291, filed on Mar. 24, 2004, now Pat. No. 6,844,819.
Application No. 10/808,291 is a continuation of application No. 10/112,446, filed on Mar. 28, 2002, now Pat. No. 6,731,218.
(60) Provisional application No. 60/212,867, filed on Jun. 20, 2000.
(60) Provisional application No. 60/908,875, filed on Mar. 29, 2007.
(60) Provisional application No. 60/700,413, filed on Jul. 19, 2005.

(51) Int. Cl. B25F 5/00; G08B 21/00

(52) U.S. Cl. 173/2; 173/20; 340/660

(57) ABSTRACT

A power hand drill or other power tool includes at least one of a detachable non-contact voltage sensing device and a detachable subsurface object locator for detecting the presence of an object beneath a surface being probed with the locator. The drill has a housing with a flat accessory mounting surface including coupling elements for coupling the sensing module to the drill. The accessory device includes a mating coupling element to engage with the coupling element in the drill housing. The non-contact voltage sensing circuitry includes sensing circuitry contained within a housing with an antenna that is positioned opposite a tool head of the power tool, and an indicator mounted to the module for indicating the presence of a voltage.

### CROSS-REFERENCE TO RELATED APPLICATIONS

This application is a continuation-in-part of U.S. patent application Ser. No. 11/179,969 filed Jul. 12, 2005, which is a continuation of U.S. patent application Ser. No. 09/884,518, filed Jun. 19, 2001, which claims the benefit of U.S. provisional application Ser. No. 60/212,867 filed Jun. 20, 2000, and is also a continuation-in-part of PCT application number PCT/US07/73892 filed Jul. 19, 2007, which claims priority to U.S. Provisional Application Ser. No. 60/908,875 filed Mar. 29, 2007, and is a continuation-in-part of U.S. patent application Ser. No. 11/458,596 filed Jul. 19, 2006, which claims priority to U.S. Provisional Application Ser. No. 60/700,413, filed Jul. 19, 2005, and is a continuation-in-part of U.S. patent application Ser. No. 11/005,187 filed Dec. 6, 2004, which is a continuation-in-part of U.S. patent application Ser. No. 10/808,291 filed Mar. 24, 2004, which is a continuation of U.S. patent application Ser. No. 10/112,446, filed Mar. 28, 2002, now U.S. Pat. No. 6,731,218, all of which are hereby incorporated by reference in their entirety.

### FIELD OF THE INVENTION

This invention relates to attachments for hand drills and other power tools, and in particular is directed to electrical sensing devices including subsurface object detectors and voltage sensing devices for attachment to power tools.

### BACKGROUND OF THE INVENTION

Carpenters, electricians, HVAC tradesmen, do-it-yourselfers and others are often faced with the problem of locating the position of live electrical wires, pipes, and wall studs behind the wall board material forming the wall surface. They are interested in hanging pictures, drilling holes and so on. However after the walls are finished and painted the location of hidden substructures (such as studs) and electrical wiring is not visually detectable.

Handheld electronic stud finders are well known. For example, U.S. Pat. No. 4,099,118 issued Jul. 4, 1978 discloses an electronic wall stud sensor which is suitable for detecting a wall stud behind a wall surface. This stud sensor uses electronic sensing circuitry to accurately determine the location of the stud behind the walls by activating the circuitry, holding the device near or against the wall and slowly moving the device until the stud is detected.

When using a stud finder, it is often necessary to also use a power drill and screw driving device for making holes in the wall and mounting a fastener. Since the two devices are often used together it would be convenient and efficient to have a single device which would perform both functions. Unfortunately, the sensing electronics of the stud finder can be affected by other electronics making it less accurate, and thus, cannot be incorporated into the drill without suitable shielding. Moreover, the sensing circuitry needs to be held near or against the surface being probed, which would be difficult if made a part of the drill.

Furthermore, when drilling into walls and other structures, carpenters, electricians, do-it-yourselfers and others often work in the vicinity of energized electrical panels and wires. Good practice dictates that these electrical circuits be de-energized when work is performed. Not infrequently, however, through error or oversight, these circuits remain in an energized condition during maintenance, thereby presenting an electrical hazard to both the worker and to the associated electrical equipment.

One particular hazard is encountered when drills and other power tools come into contact with the live electrical circuits. When this occurs, both injury to the worker and damage to the electrical equipment can occur.

Due to these problems, non-contact voltage indicators, useful to probe for a live wire, are available. These indicators provide a visual or audio indicator to the user when the indicator is placed in the vicinity of an AC voltage source. An example of a device of this type is shown, for example, in U.S. Pat. No. 5,877,618 “Hand Held Non-Contact Voltage Tester”. While useful in providing an indication of a live wire, successful use of this device requires the user to test the wire before work is begun. The test, therefore, does not solve the initial problem: erroneously or mistakenly forgetting to disable or verify disablement of the circuit before work is begun. These prior art devices, however, cannot actively alert the user of the possibility of hazardous voltages on the wires, cables or other electrical devices prior to potentially dangerous contact. Moreover, like the stud seekers described above, these devices cannot be easily incorporated into power tools, due to interference with the internal circuitry and electronics.

Thus there remains a need for a power tool that can intrinsically alert a user when the tool is placed in the vicinity of a wire or cable that has a hazardous voltage impressed on it.

### SUMMARY OF THE INVENTION

In one aspect, the present invention provides a power tool having a housing including an accessory mount. The accessory mount includes at least one of a groove and a rail. The accessory mount receives a detachable non-contact voltage sensing accessory, comprising a housing, a non-contact voltage sensing circuit received in the housing, and at least one indicator providing an alarm signal indicating that the hand tool is in proximity to a live electrical wire. The non-contact voltage sensing accessory including at least one of a groove and a rail adapted to be coupled to the other of a groove and rail provided in the accessory mount for retaining the accessory in the accessory mount.

In another aspect of the invention, the accessory mount includes first and second opposed side walls, and at least one of a rail and a groove formed in each of the first and second side walls. The accessory mount can also include a substantially flat receiving surface for receiving the non-contact voltage sensing accessory, and first and second opposing side walls on opposing sides of the receiving surface, the opposing side walls each including the at least one of a rail and a groove formed in the opposing side walls.

In yet another aspect of the invention, the accessory can include a front wall at a first end of the receiving surface of the accessory mount, coupling the opposing side walls, and a shock absorber coupled to the front wall. The non-contact voltage sensing accessory can also include a multi-directional switching element, the multi-directional switching element allowing activation from a top side of the accessory and from opposing sides of the accessory. The non-contact voltage sensing circuit can also include an antenna located at the end of the tool opposite the tool head.

In still another aspect of the invention, the power tool can be a drill, a reciprocating saw, or a hammer drill.

In still yet another aspect of the invention, a power tool is provided, including a housing having an accessory mount including a first coupling element, and a tool head extending from the housing. A detachable non-contact voltage sensing accessory, comprising a housing including a second coupling element, a non-contact voltage sensing circuit received in the housing, and at least one indicator providing an alarm signal indicating that the hand tool is in proximity to a live electrical wire, the non-contact voltage sensing accessory including an antenna received in the accessory mount to position the antenna at an end of the power tool opposite the tool head.

In still another aspect of the invention, a tool is provided. The tool includes a an accessory mount having at least one of a groove and a rail, and a tool head coupled to the accessory mount. The detachable sensing circuit is received in the accessory mount, and at least one indicator is included to provide an alarm signal indicating that the sensing circuit has been activated, the sensing accessory including at least one of a groove and a rail adapted to be coupled to the other of a groove and rail provided in the accessory mount for retaining the accessory in the accessory mount.

The sensing accessory can be a multi-scanner, a non-contact voltage sensor, and a subsurface object locator. The tool head can be a power drill, a knife, a pliers, a wire cutter, a wire stripper, a saw, or a screwdriver. The accessory mount can be included in either a housing or a handle coupled to the tool head.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a cordless hand drill including a subsurface object locator of the invention;

FIG. 2 is a view similar to FIG. 1 from a different angle;

FIG. 3 is a view similar to FIG. 2 but with the subsurface object locator removed from the drill housing;

FIG. 4 is a view similar to the preceding views but showing how the subsurface object locator is reattached to the drill housing;

FIGS. 5a-5e are perspective (FIGS. 5a and 5b), top (FIG. 5c), side (FIG. 5d), front (FIG. 5e) and rear (FIG. 5f) views of the main housing of the subsurface object locator;

FIGS. 6a-6d are perspective (FIG. 6a), top (FIG. 6b), side (FIG. 6c), and front (FIG. 6d) views of a button for the subsurface object locator;

FIGS. 7a-7c are perspective (FIG. 7a), top (FIG. 7b), and side (FIG. 7c) views of a bottom cover for the subsurface object locator;

FIGS. 8a-8e are perspective (FIG. 8a), top plan (FIG. 8b), side (FIG. 8c), bottom (FIG. 8d), and rear (FIG. 8e), views of a mounting plate which forms a part of the housing of the drill and detachably mounts the subsurface object locator;

FIG. 9 is a schematic diagram of a circuit for practicing the invention; and

FIG. 10 is a schematic diagram illustrating the operation of the circuit.

FIG. 11 is a perspective view of a drill constructed in accordance with an alternate embodiment of the invention including a module for non-contact voltage sensing.

FIG. 12 is a partial view of the drill of FIG. 11 showing the module as removed from the housing.

FIG. 13 is a perspective view of a drill constructed in accordance with another embodiment of the invention, and illustrating multiple mounting locations for a removable non contact voltage sensing module.

FIG. 14 is a partial view of the side handle of the drill of FIG. 13, illustrating the module removed from the accessory mount.

FIG. 15 is an alternate embodiment of the invention, illustrating a non-contact voltage sensing module provided in an attachment member of a reciprocating saw.

FIG. 16 is a partial view of the housing of the saw of FIG. 15, illustrating the module as removed from the accessory mount.

FIG. 17 is a bottom perspective view of the voltage sensing accessory of FIGS. 11-16;

FIG. 18 is a top perspective view of the voltage sensing accessory of FIG. 17;

FIG. 19 is an exploded view of the voltage sensing accessory of FIG. 17;

FIG. 20 is an exploded view of the voltage sensing accessory of FIGS. 11-16 as received in an accessory mount in a power tool or other device;

FIG. 21 is a cutaway side view of the voltage sensing accessory of FIGS. 11-16 as received in an accessory mount in a power tool or other device;

FIG. 22 is a cutaway view taken along a line drawn through a first embodiment of the switching element of the accessory of FIGS. 11-16 as received in an accessory mount in a power tool or other device;

FIG. 22A is a cutaway view taken along a line drawn through the switching element of the accessory of FIG. 30, and illustrating activation of a first embodiment of a switching element when a downward force is applied;

FIG. 22B is a cutaway view taken along a line drawn through the switching element of the accessory of FIG. 30, and illustrating activation of a first embodiment of a switching element when a sideway force is applied;

FIG. 23 is a partial cutaway view of an end of the accessory received in the accessory mount, and illustrating a shock absorbing element;

FIG. 24 is a bottom view of a cover of the switching element of the accessory of FIG. 17;

FIG. 25 is a perspective view of a circuit board for a non-contact voltage sensing circuit provided in the accessory of FIG. 17;

FIG. 26A is a is a cutaway view taken along a line drawn through a second embodiment of a switching element of the accessory of FIG. 17;

FIG. 26B is a cutaway view taken along a line drawn through the switching element of the accessory of FIG. 17, and illustrating activation of the second embodiment of a switching element when a downward force is applied; and

FIG. 26C is a cutaway view taken along a line drawn through the switching element of the accessory of FIG. 17, and illustrating activation of the second embodiment of a switching element when a sideway force is applied.

FIG. 27 is a perspective view of a plurality of hand tools constructed to receive the accessory of FIG. 17.

### DETAILED DESCRIPTION OF THE PREFERRED EMBODIMENT

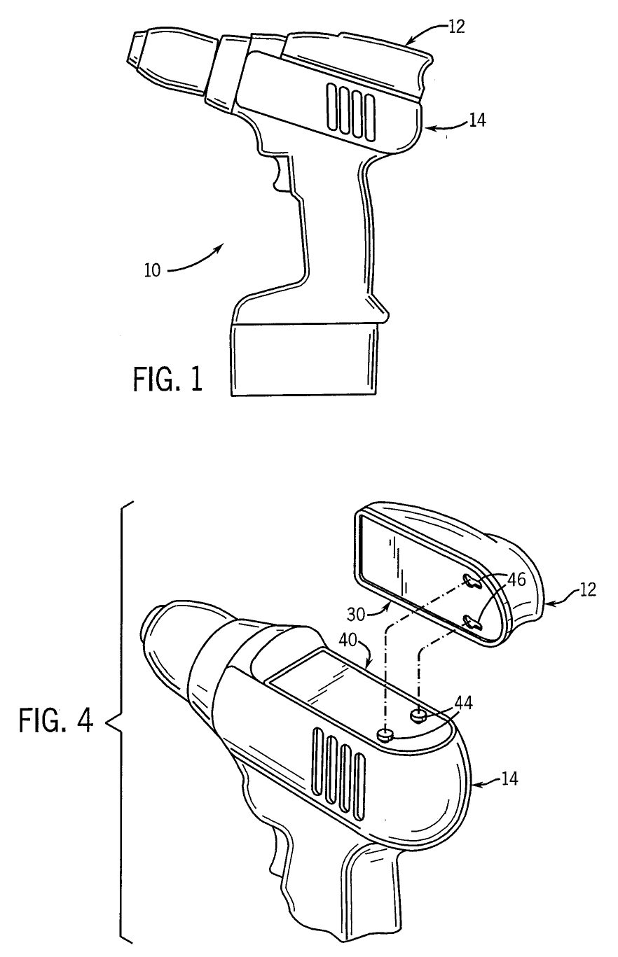

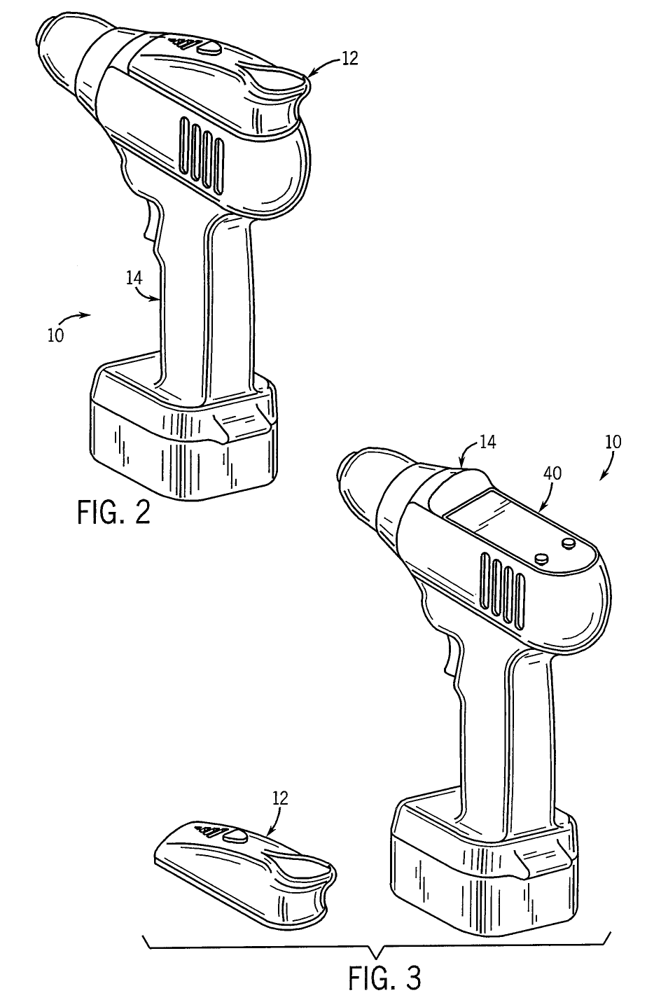

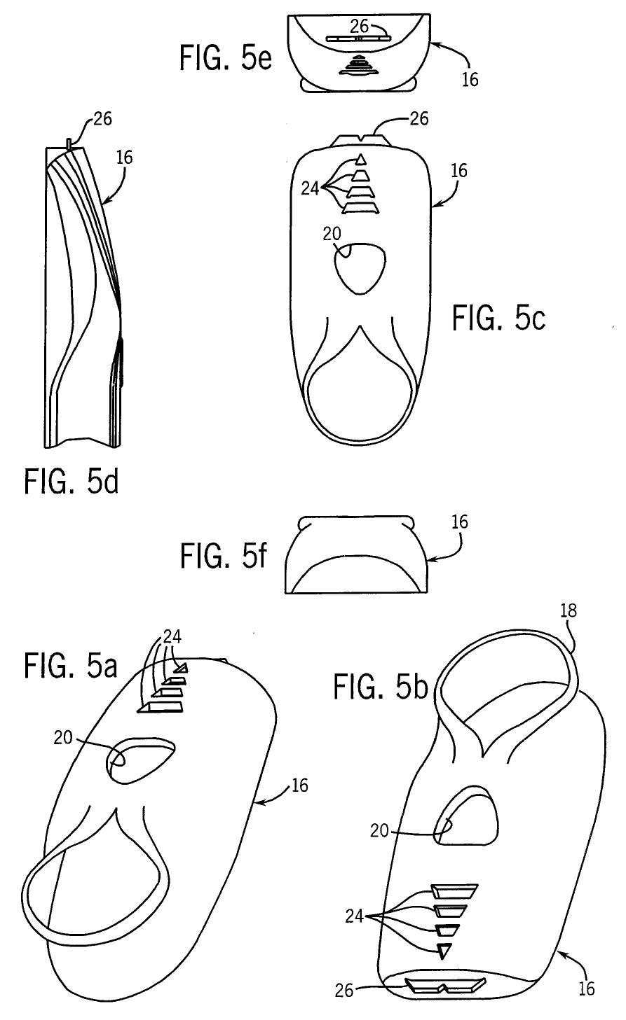

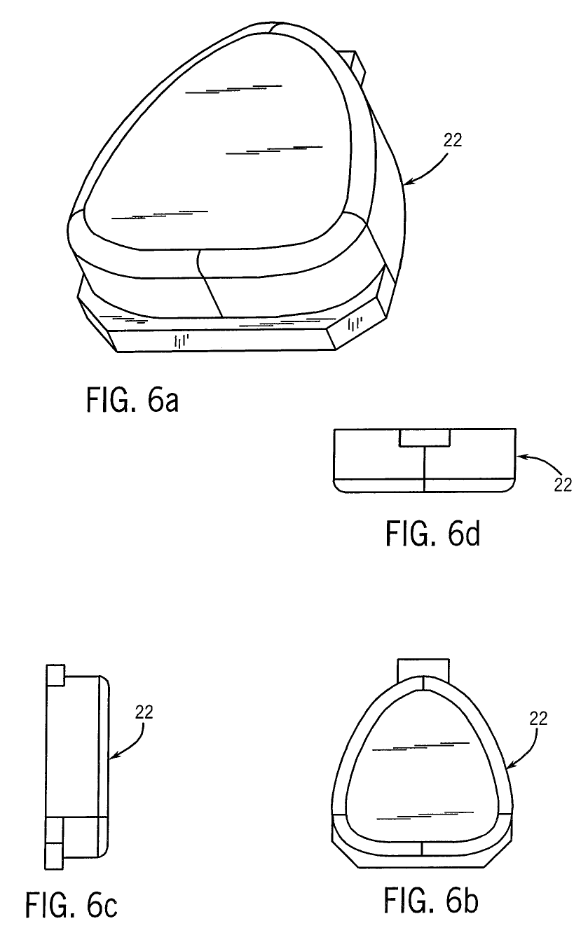

Referring to FIGS. 1-4, a drill 10 of the invention includes a subsurface object locator 12 detachably mounted to the drill housing 14. The drill 10 as illustrated is a cordless drill, although it could be provided with a cord for power with the locator 12 in the same position. Referring particularly to FIGS. 5a-5e, the locator 12 has a main housing 16 which is contoured to fit to the shape of the housing 14 and provide a handrest 18 at the rear of the housing 16 which is contoured to fit a user's hand and provide a surface for thrusting against the rear of the drill with the users hand so as to operate the drill. The main housing 16 also has a buttonhole 20 into which the button 22 (FIGS. 6a-6d) fits for turning on the locator. The housing 16 also has indicator light openings 24 which are covered with an appropriate lens so that an indication of when the locator 12 senses a subsurface object can be given to the user by illuminating LEDs through the windows 24 as more fully described below. In addition, the housing 16 has a tongue 26 extending from its front end which fits into a slot 27 of the housing 14 to help secure the locator 12 and align it to the contours of the housing 14.

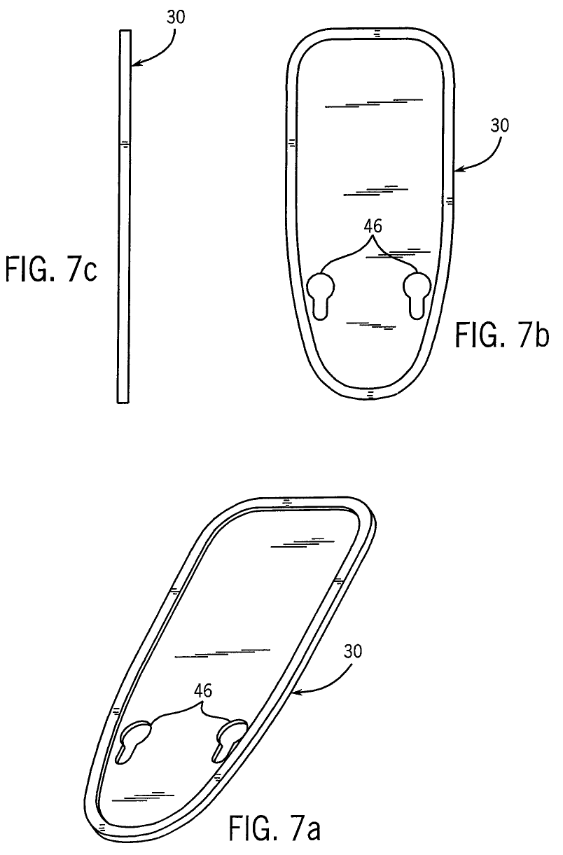

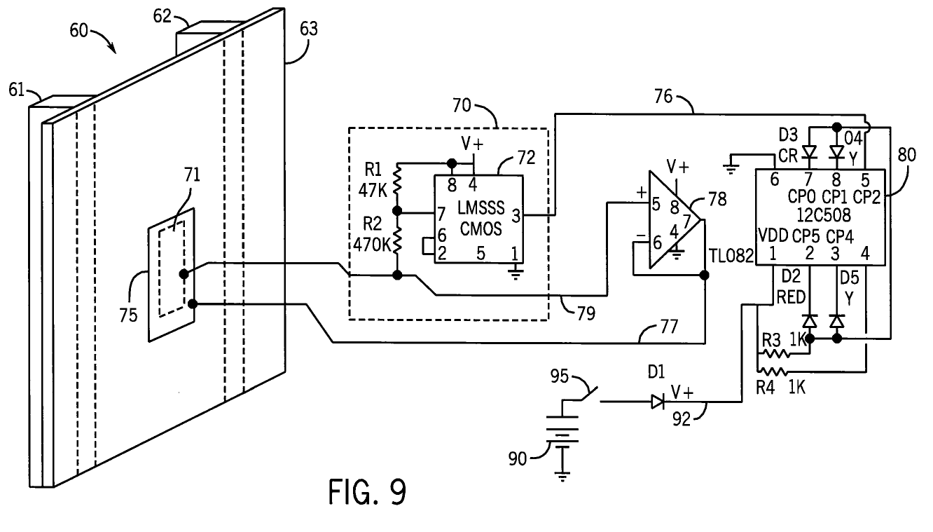

As shown in FIGS. 7a-7c, a back plate 30 is attached to the bottom of the housing 16 by any suitable means, such as glue, ultrasonic welding or other means. A sensor plate 71 (see FIG. 9) is made substantially as large as the bottom plate 30, to maximize the sensitivity of the subsurface object locator. The circuitry of the locator is housed between the bottom plate 30 and the housing 16, and is operated by the button 22. Thus, to sense a subsurface object, the locator 12 is removed from the drill housing 14, and its bottom is slid over the surface being sensed while holding down the button 22. The indicator lights visible through openings 24 then indicate the edges of the subsurface object.

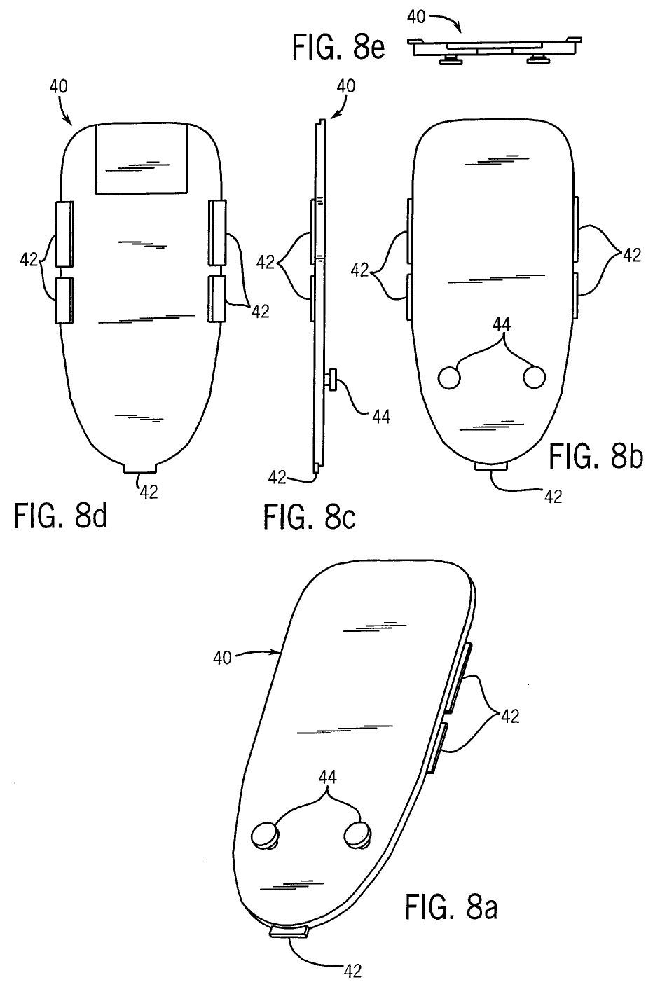

Referring to FIGS. 8a-8e, and also FIG. 3 and FIG. 4, a mounting plate 40 for mounting the locator 12 is fixed to the drill housing 14 by any suitable means. As illustrated, the plate 40 is fixed with a snap fit, having tabs 42 around its periphery which fit with corresponding slots or grooves in housing 14 to secure the plate 40. Any other suitable attachment means such as screws, adhesive or other means may also be used.

The plate 40 has two projections 44 with enlarged heads which fit into keyhole shaped openings 46 in the plate 30 to secure the locator 12 to the housing 14. As mentioned above, the tongue 26 of the housing 16 fits into a correspondingly shaped opening in the housing 14 when the projections 44 are fit into the large ends of the openings 46 and the locator 12 is slid forward so as to secure it with a friction fit of the projections 44 entering the small ends of the openings 46. Any other detachable connection of the locator 12 to the housing 14 could also be used.

Shown in FIG. 9 is a portion of a wall structure 60, studs 61, 62 and wall board 63 to be illustrative of one way of operating the invention. In this case, it is desired to locate the positions of the hidden studs 61 and 62. Although any suitable circuitry can be used, one possible circuit (shown in FIG. 9) includes a metallic sensor plate 71 connected to a CMOS oscillator 70 which produces a square (or rectangular) wave output. The circuit consists of a timer IC 22, the sensor plate and resistors. The frequency of the oscillator 70 is determined by IC 72, the values of resistors R1 and R2 and the capacitance presented by the plate 71.

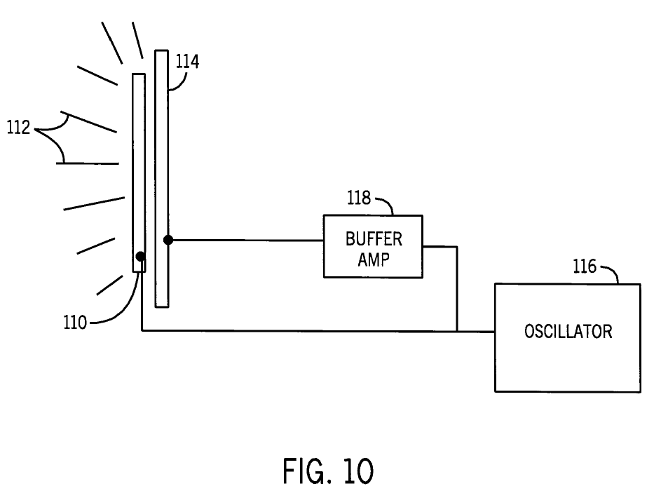

Referring to FIGS. 9 and 10, when the sensor plate 71 is above a section of the wall with no studs it will cause the oscillator 70 to run at a first frequency (f1). When the sensor is above a section of the wall that has a stud below it the oscillator will have a different frequency (f2). The capacitance of the plate 71 is determined by the surrounding medium including the wall material, the studs, the circuit and the person holding the device. It is desirable to reduce the stray capacitance as much as possible since this will improve the sensitivity of the plate 71. The capacitance of plate 71 is influenced considerably by the operator and the housing of the device.

Capacitance is related to its potential with respect to other objects. If an additional plate 75 is introduced in the vicinity of plate 71 with the same potential as plate 71, it will reduce the “stray” effects. This improves the sensitivity of the plate 71 and allows it to sense further into the wall.

The potential of plate 71 changes as the oscillator 70 operates. In a typical situation it may vary from 0 to 5 volts in amplitude. Hence the guard plate 75 must have its potential vary in the same way. This is accomplished by using a buffer amplifier 78, with a gain of one, which has the voltage of the sensor plate 71 at its input and produces a near exact replica of it at its output, which is connected to plate 75 via line 77. Hence plate 75 is driven at the same potential as plate 71.

As shown in FIG. 10, the sensor plate 71 is connected to the oscillator 70 and the guard plate 75 is driven from amplifier 78 so it has the same potential as the sensor plate 71. The E-field 100 is now prevented from going in the direction of the guard plate 75. This is because both plates are at the same potential and by electrical laws there can be no E-field between conductors of the same potential. With fewer E-field lines, there is less capacitance of sensor plate 71. Hence it will be more responsive to dielectric changes in the direction opposite to the guard plate 75. The guard plate 75 may be somewhat larger than the sensor plate 71 so as to extend beyond the edges of the sensor plate 71, which redirects the E-field lines emanating from the edges of the sensor plate 71 in the direction toward the surface being probed.

The microprocessor circuit 80 is programmed to measure the frequency difference f1 minus f2, which can be done by any suitable means. For example, the microprocessor circuit 80 will typically include a counter. The counter can be programmed to count the number of times the oscillator output signal to the microprocessor goes high in a certain period, which yields a measure of the frequency of the oscillator output. If the frequency difference between the first measured frequency and the subsequently measured frequencies exceeds an amount deemed sufficient to indicate the presence of a stud, an LED is turned on.

The circuit 80 actually has four LEDs D2, D3, D4 and D5 that can be activated at different amounts of frequency change. More or fewer LEDs could be used as indicators depending upon resolution and cost considerations. The circuit is powered by batteries 90 (e.g., four 1.5V pancake cells) through protective diode D1 (e.g., a 1N270 diode) and line 92. Resistor R3 is used to limit the current in the LEDs. Resistor R4 is used for a power on reset for circuit 80. Button 22 operates switch 95 to enable power to circuit from the battery 90 to circuit 80.

Although visual LED indicators D2-D5 are described here, it should be clear that audible indicators could be used as well. For example, different audible tones could be produced corresponding to various frequency differences encountered in scanning the wall, as the leading edge of a stud was approached, the frequency could go up, and as the trailing edge of the stud was passed the frequency could go down. In fact, there are occasions where audible indications may be better, such as in cases where the visible indicators may be hard to see.

As the sensor is moved along the wall the frequency changes. As the frequency decreases, the circuit 80 senses this change and turns on one or more of the LEDs D2-D5. The LEDs could be turned on so as to overlap in on-times or not. In the preferred embodiment, the on-times do not overlap to preserve battery power.

To use the device described, the sensor plate 71 is placed on or in close proximity to the wall where there are no studs and the button 22 is pressed which closes the switch 95. This causes circuit 80 to be activated and it will measure the first frequency f1 from the oscillator 70 and save it in memory. After this step is performed, which takes less than a second, the lowest LED D3 (green) comes on and stays on as a power indicator, while the button 22 is pressed. This signals to the operator that the device can now be moved across the wall being probed. As the sensor is moved across the wall the circuit 80 is continuously measuring the second or subsequent frequency f2 from oscillator 70 and comparing it to the first frequency f1 by taking the frequency difference. When the difference exceeds a first threshold, the next LED up, LED D4 (amber) will be lit and LED D3 will go out. When the difference exceeds a second threshold, greater than the first threshold, the next LED D5 (amber) will be turned on and LED D4 will go out. When the difference exceeds a third threshold, greater than the second threshold and which indicates the presence of the leading edge of the stud, the highest LED D2 (red) goes on and the LED D5 goes out. LED D2 stays on as the thickness of the stud is traversed by the device. When the trailing edge of the device is reached, the LEDs go off and on in the reverse sequence. Thus, a user trying to find a stud, will mark the leading edge of the stud when LED D2 comes on, and will mark the trailing edge of the stud when the LED D2 goes off.

When a user first puts the device against a wall or other surface to be probed, there is no way of telling if it is initially placed over a stud or other subsurface object or not. The device assumes that it is not. However, if by chance it is, then the subsequently found frequency difference will be negative and unless special provision is made in the programming of the microprocessor, an error will result. It is an easy matter, however, to program the microprocessor so that if the f1−f2 frequency difference is found to be negative, it means that the device was initially placed over a stud or other subsurface object. The device could be programmed to flash the LEDs or beep a buzzer in that event to alert the user to start over, placing the device in a different initial position.

Referring again to FIGS. 1-3 and 5d, the drill housing houses a motor along an axis substantially parallel to the mounting surface 40, and a handle portion along an axis substantially perpendicular to the mounting surface 40.

The housing 16 of the locator 12 slopes upward from the front end adjacent the tongue 26. The sloped portion provides a grip allowing the operator to grasp the housing 16 of the locator 12 and to slide the housing 16 rearwardly for removal from the drill housing 14.

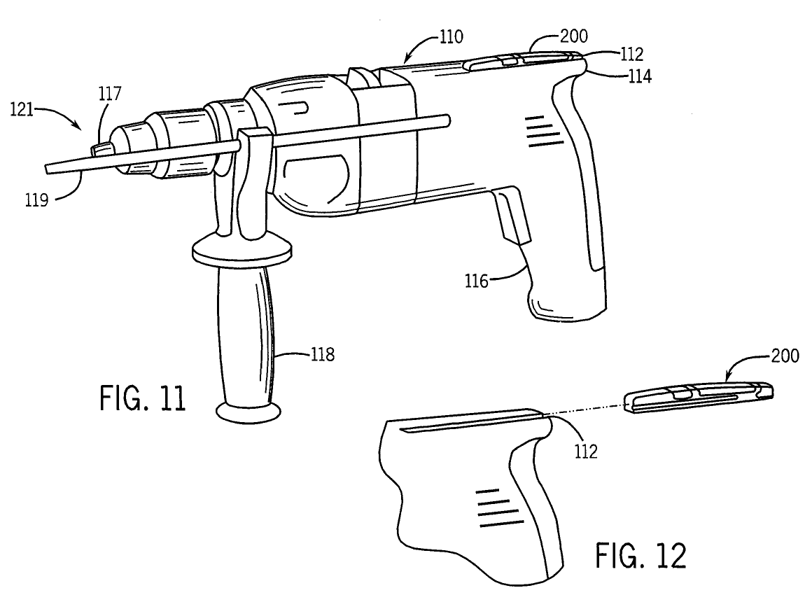

Referring now to FIG. 11, an alternate embodiment of a drill 110 constructed in accordance with the present invention is shown. The drill 110 is a hammer drill including a housing 114 in which a slot 112 including an accessory mount 238 is formed in the upper surface. The slot 112 receives a modular sensing device 200 which can be a subsurface object or stud seeker, as described above, or alternately a non-contact voltage sensing device, as described more fully below. The hammer drill 110 includes a handle 116 extending from a back of the housing 114, and a side handle 118 which, as shown here, is coupled to a depth gauge 119 for use in a drilling operation. A chuck 117 is provided at an end of the housing 114 opposite the handle 116, and is sized and dimensioned to receive a drill bit to provide a tool head 121 for drilling into a wall or other surface. Although a hammer drill is shown here, it will be apparent that many types of drills and other types of power tools can also be used in the present invention.

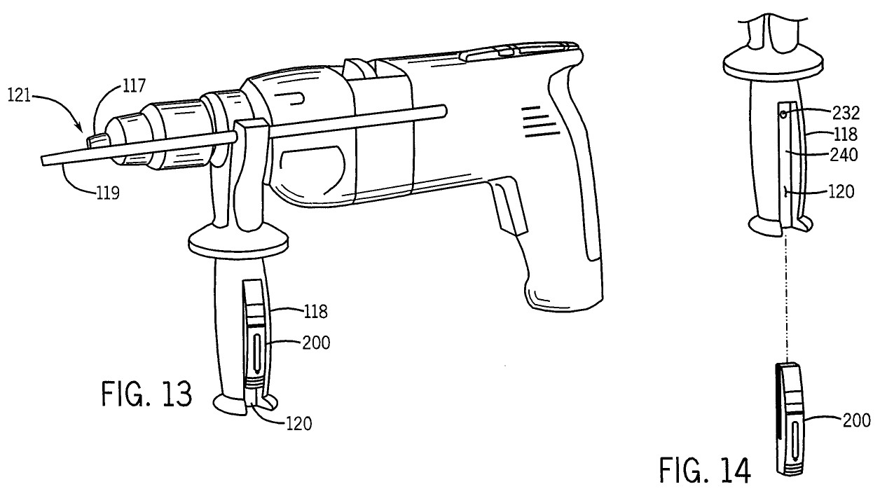

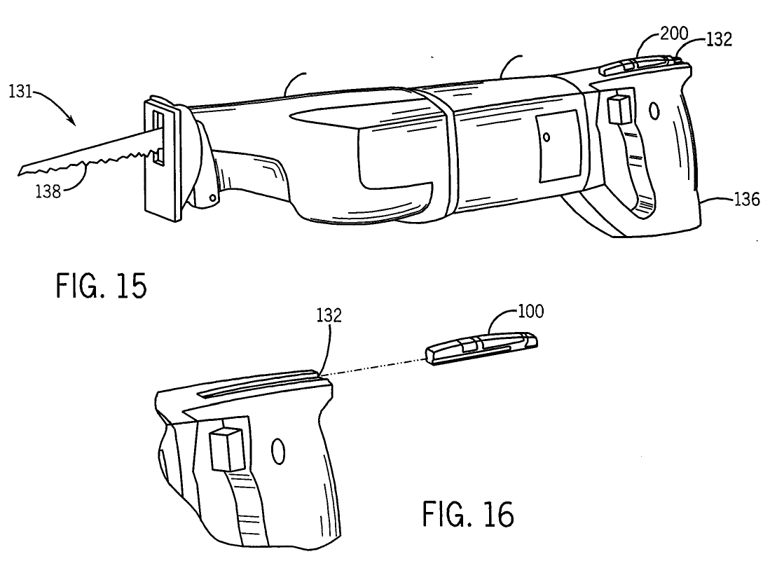

Referring now to FIG. 12, the module 200 can be selectively inserted into or removed from the slot 112 formed in the housing as described more fully below. Referring now to FIGS. 13 and 14, an alternate embodiment is shown in with the slot 120 is formed in the side handle 118 of the hammer drill 110. The slot 120 is sized and dimensioned to receive the module 200, as described below. Referring now specifically to FIG. 14, the slot 120 includes a substantially flat lower surface 240 and a projection 232. It is sized and dimensioned to meet with a bottom surface of the module 200 for coupling module to the handle as described more fully below.

Referring now to FIGS. 15 and 16, an alternate embodiment of a power tool constructed in accordance with the present invention as shown. Here the power tool 130 is a reciprocating saw including a housing 134 and a tool head 131 comprising a blade 138 extending from one end. A handle 136 is formed at the back end of the housing and includes a slot 132 provided in the upper surface of the housing 134 for receiving a module 200 which, as shown in FIG. 16, can be slid into and out of the slot 132, as described below.

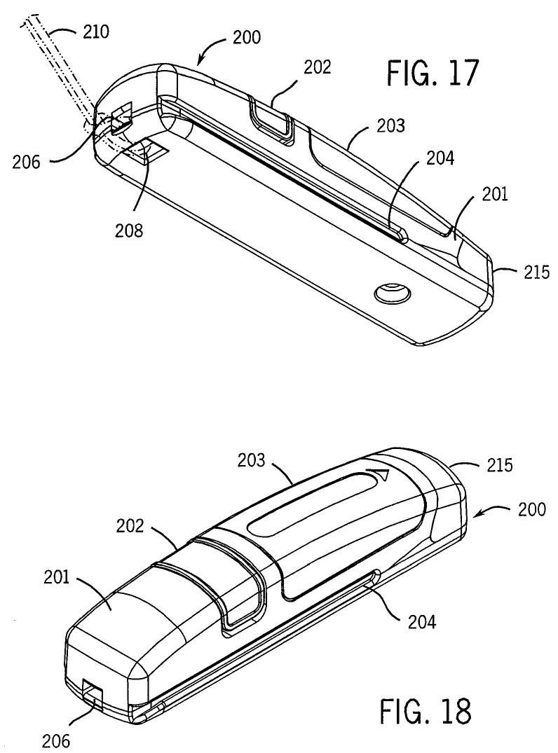

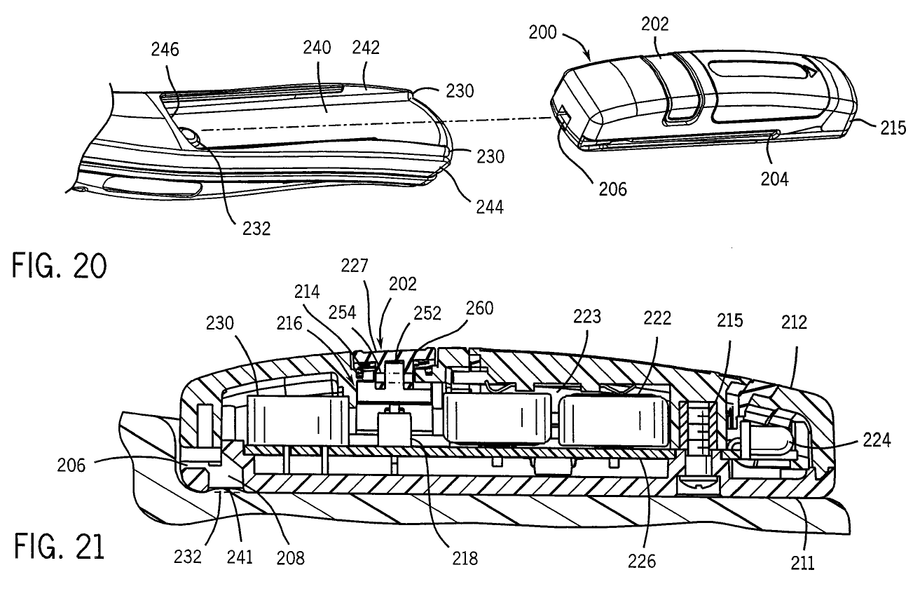

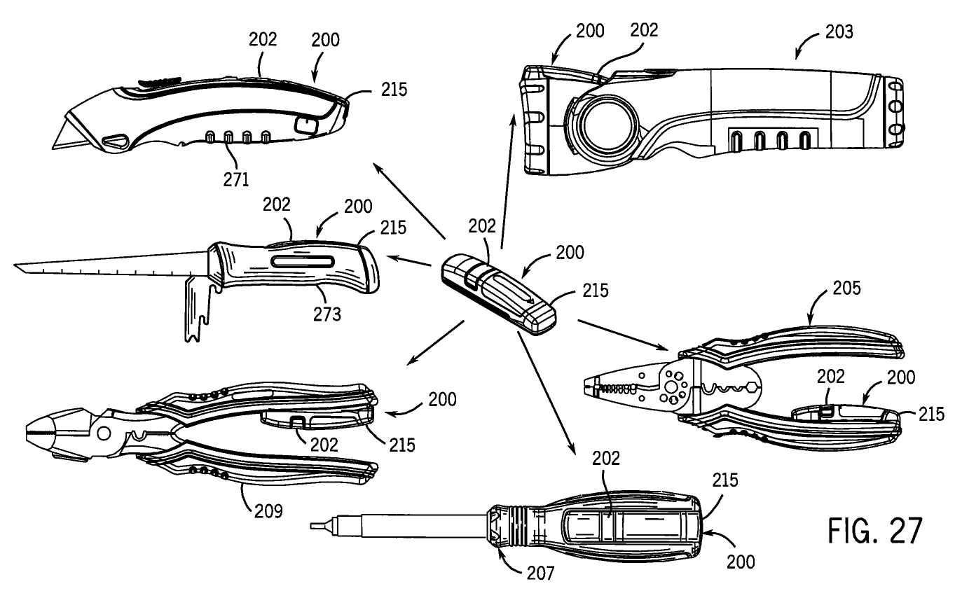

Referring now to FIGS. 17 and 18, an accessory comprising a non-contact voltage sensing module 200 is shown including a housing 201 storing the non-contact voltage sensing circuitry, a multi-directional switching element 202, a visual indicator 215, and a battery compartment 203. The housing 201 also includes a number of coupling elements for mating the module 200 with an accessory mount 238 (FIG. 20, FIG. 27) formed in a slot 112 (FIG. 11, 12) or 132 (FIG. 15, 16) in a power tool or other device, as discussed below. These coupling elements can include a groove 204 formed in at least one, and preferably in opposing sides of the housing 201, and a depression or cutout 208 formed in the bottom surface of the housing 201. An aperture 206 can also be provided in the front surface of the housing 201, and a conduit provided between the aperture 206 and cutout 208 to provide a continuous opening through the housing 201 to allow a user to connect an elongate coupling element 210 through the conduit. The elongate coupling element can be, for example, a lanyard, a string, a key ring, or other devices.

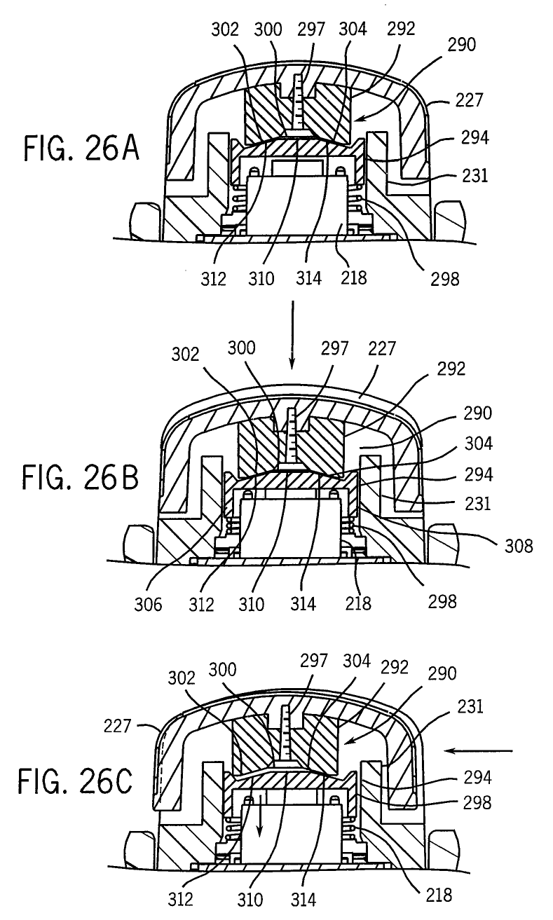

Referring now also to FIG. 20 and FIG. 26, devices constructed to receive the module 200, such as the power tool described with reference to FIGS. 11-16, above, include an accessory mount 238 that is formed in the housing of the device. The accessory mount 238 includes a front wall 246 and side walls 242 and 244 which surround an opening including an open distal end for receiving the module 200. Rails 230 are formed in the sides 242 and 244, extending into the opening formed between the side walls 242 and 244. The receiving surface 240 includes an upwardly extending projection 232, which can be, as shown here, a raised spherical bump mounted on a flexible element 241 such as a three-sided cutout in the receiving surface 240. Although a cut-out is shown and described here, it will be apparent that various methods of providing a flexible surface or projection are available, and any of these methods can be used in the present invention.

Referring still to FIG. 20, the groove 204 formed in the side of the housing 201 of the module 200 is sized and dimensioned to mate with the rail 230 formed in the accessory mount 238, and the depression or cutout 208 formed in the bottom surface of the housing 201 of the module 200 is sized and dimensioned to mate with the projection 232 formed in the receiving surface 240 of the accessory mount 238 in the tool to provide a detent locking apparatus. Therefore, for storage, the module 200 is slid onto the receiving surface 240 such that the grooves 204 are inserted over the rails 230, and is slid forward until the cutout 208 mates with the projection 232. Referring now also to FIG. 23, a shock absorber or bumper 234, comprising a soft, flexible material such as a rubber or soft plastic, can be provided in a front wall 246 of the accessory mount 238 to absorb energy in the event that the tool is dropped, thereby protecting the module from breaking.

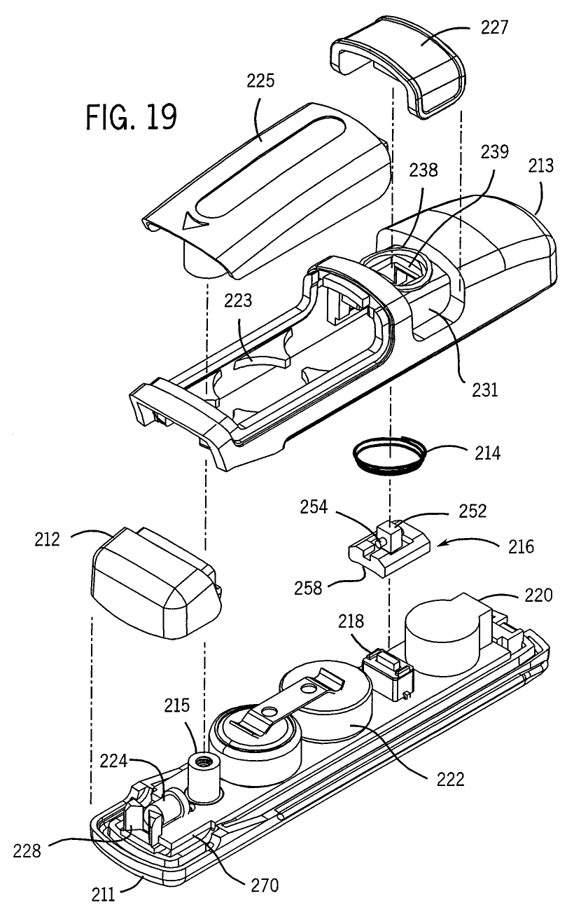

Referring now to FIG. 19, an exploded view of the non-contact voltage sensing module 200 is shown. The housing 201 includes a base 211 and cover 213. A battery compartment 223 is formed in the cover element 213 of the housing, which is enclosed by a battery access cover 225. Similarly, a switching compartment 231 is formed in the cover 213 which interacts with switching components and a switch compartment cover 227 to provide the multi-directional switching element 202, as described below. To provide a visual signal to the operator when a voltage is detected, the cover element 213 is discontinuous at the distal end of the module 200, and a translucent cover 212 encloses this end of the module. Although a separate translucent cover is shown, the entire cover 213 could also be constructed of a translucent material.

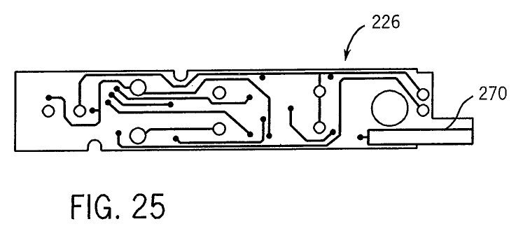

Referring still to FIG. 19, a printed circuit board 226 is mounted to the base 211 and includes a non-contact voltage sensing circuit, such as the circuit as described and shown in FIG. 11 of U.S. Patent Application Publication 2005/0104735, published May 19, 2005, a parent case to the present application, which is hereby incorporated by reference for its description of this circuit. The circuit includes visual and audio indicators, LED 224 and speaker 220, respectively, a bank of batteries 222, and a switch element 218. A pair of reflectors 228 are positioned adjacent the LED 224 to reflect light more fully along the translucent plastic cover 212, thereby amplifying the light from the LED 224 to increase the visual indicator. Referring now also to FIG. 25, an antenna element 270 is formed on the printed circuit board 226 and is positioned adjacent the LED 224. As positioned in the module 200, the antenna 270 is therefore positioned at the distal end of the module, and adjacent the visual indicator. When positioned in a tool with a tool head, as shown in FIG. 30, the visual indicator 215 is at the opposing end of the tool from the tool head.

Referring still to FIG. 19, the switching element 202 includes the switch 218 mounted to circuit board 226, a rocker element 216 mounted above the switch 218, the switch compartment 231, a spring 214, and the switch cover element 227. These components act together to provide multi-directional switching.

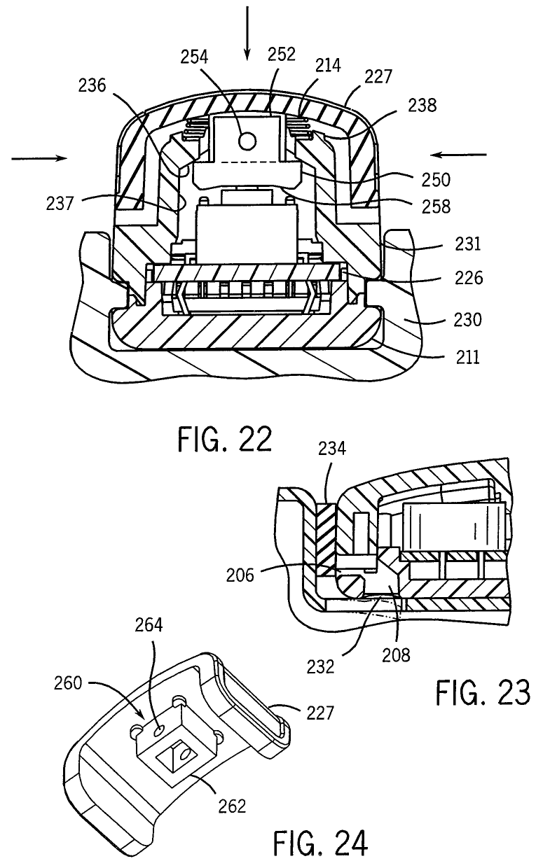

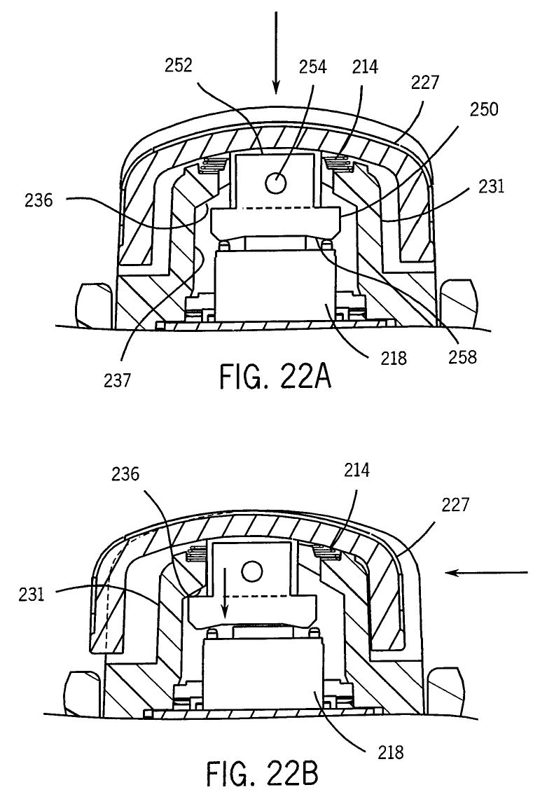

Referring still to FIG. 20 and also to FIGS. 21 and 22, the rocker element 216 includes a center post 252 mounted on a base member 250, the center post 252 including pins 254 and 256 extending from opposing sides. As best seen in FIG. 22, the lower surface of the base member 250 is substantially flat in a center portion, but slopes downward at the opposing ends, providing a generally thicker profile at the opposing ends of the base member 250. Referring now specifically to FIG. 21 and also to FIG. 24, the switch cover element 227 includes a rocker mounting block 260 that extends from the lower surface of the cover 227. The rocker mounting block 260 is generally rectangular, and is sized and dimensioned to receive the center post 252 of the rocker element 216, and includes apertures 262 and 264 for mating with the pins 254 and 256 in the rocker element 216.

Referring again to FIG. 20 and also to FIG. 22, the switch compartment 231 in the housing 201 includes a generally circular mounting element 238 for receiving the spring 214, and an interior wall 239 sized and dimensioned to receive the rocker element 216 extending from the bottom of the cover 227. Referring now specifically to FIG. 22, an interior surface 237 of the switch compartment 231 includes a sloped wall 236, positioned adjacent the upper surface of the base 250 of the rocker element 216.

Referring now to FIG. 22A, when the switching element 202 is activated by a force applied directly from the top surface, the cover 227 forces the rocker element 216 directly down onto the switch 218, activating the switch. When released, the spring 214 forces the cover 227 back up into position. Referring now to FIG. 22B, when a force is instead applied to the side of the switching element 202, the rocker element 216 moves along the sloped wall 236, forcing the thicker portion of the base element 250 onto the switch element 218 and activating the switch. Again, when the switching element 202 is released, the spring 214 forces the rocker switch 216 back into position. Therefore, the switching element 202 can be activated from the top, from either of the opposing sides, and even by applying a force to the corner of the switch. This switch configuration allows the module 200 to be stored in a housing of a hand tool or other device in a number of different ways, while still allowing the switch 218 in the module 200 to be easily activated by a user.

Referring now to FIGS. 26A-26C, an alternate embodiment of a switching element 202 is shown. Here, as described above, the switching element 202 includes a switch 218 mounted to the circuit board, a rocker element 290, a switch compartment 231 formed in the housing 201, and a cover 227 that is provided over the switch compartment. The rocker element 290 comprises an upper section 292 that is coupled to the cover 227 with a threaded fastener 297, and a lower section 294 that is generally U-shaped, and is positioned over the switch 218 with the arms 306 and 308 on opposing sides of the switch 218. The bottom surface of the upper section 292 includes a generally flat center portion 300, and downwardly sloped side portions 302 and 304. Similarly, the top surface of the lower section 294 includes a substantially flat center portion 310, downwardly sloped portions 312 and 314, and upwardly sloped distal ends sloping to a high point generally above the arms 306 and 308. A spring 298 is provided between the lower section 294 and the printed circuit board 226.

Referring now specifically to FIG. 26B, when a downward force is applied to the cover 227 to activate the switching element 202, the arms 306 and 308 of the lower section 294 compress the spring 298 and the upper section 292 forces the lower section 294 onto the switch 218, activating the switch. Referring now to FIG. 26C, when a sideway force is instead applied, the upper section 292 moves along the slopes in the upper surface of the lower section 294, forcing the arm 306 down and activating the switch 218. A force from the opposing side results in a similar activation. In either case, when the applied force is removed, the spring 298 forces the rocker element 290 back to the neutral position of FIG. 22A.

Referring again to FIG. 20, to store the module 200 in the housing of a drill or power tool (FIGS. 11-16), the module 200 is slid onto the receiving surface 240 of the accessory mount 238, and the grooves 204 formed in the sides of the housing 201 of the accessory mount are received in the rails 230 provided in opposing sides 242 and 244 of the accessory mount 238. As the module is moved over the receiving surface 240, the flexible element 241 and projection 232 are forced downward, and spring back into position when the depression 208 (FIG. 17; FIG. 21) is positioned over the projection 232 (FIG. 21), providing a “click” sound to the operator indicating that the module 200 is in position. After the module is “clicked” into position, the connection between the rails 230 and grooves 204, and the connection between the projection 232 and depression 208 together retain the module 200 on the accessory mount 238. The bumper 234 (FIG. 23) limits shock forces on the module when the corresponding tool or device is dropped, thereby limiting the possibility that the module 200 will be ejected from the accessory mount 238 if the device is dropped.

Although specific embodiments are described above, it will be apparent that a number of modifications could be made within the scope of the invention. For example, although specific subsurface object locators and non-contact voltage sensing accessories for attachment to power tools and other devices have been shown and described above, it will be apparent that various types of electronic circuits could be provided in the power tools. The circuits can include a subsurface object locator, non-contact voltage sensing accessory, or both. Additionally, a multi-scanner, which includes circuitry for wood stud detection, metal stud detection, and non-contact AC voltage detection can also be provided in the module. A multi-scanner device of this type is known in the art, and typically includes a switch for switching between the various optional circuits. A device of this type is disclosed, for example, in U.S. patent application Ser. No. 11/840,616, filed Aug. 17, 2007, which is hereby incorporated by reference for its description of such a device. Any of these types of circuits, or combinations of these circuits, can be provided within a module 200.

Although the module 200 is described above as removably coupled to a power tool such as a drill, the module 200 can also be coupled to hand tools. Referring now to FIG. 27, a perspective view of a module 200 selectively received in each of a plurality of hand tools, including a flashlight 203, a wire stripper 205, a screwdriver 207, a side cutting pliers 209, a retractable knife 271, and a saw 273 which, as shown here, includes a wire stripper attachment. Each of the tools include an accessory mount 238 formed in a housing to removably receive the non-contact voltage sensing accessory 200, as described more fully below. The non-contact voltage sensing module 200 can be selectively stored in the accessory mount formed in the housing of the tool, and either used while stored in the tool, or selectively removed for use when desired.

Furthermore, although specific housings for the voltage sensing accessories are illustrated and described, it will be apparent that the shape of the housing can be modified to mate with various types of tools and coupling devices. Thus, for example, in some applications it will be desirable for the housing to include a flat surface. In other applications, the surface could be concave, convex, or provided in other shapes and forms.

Additionally, while described above as specifically mounted to an upper housing surface or a handle of a power tool, the module can be mounted to various portions of a tool, and will be apparent to those of ordinary skill in the art. Furthermore, while specific types of tools and devices are described above, the accessory could be used with virtually any type of power tool or device, or attached to various portions of the body of a user, a toolbox, a tool belt, or in other locations, and could be mounted either externally to the tool, or internally in a body, head, handle, or other component of the tool.

Furthermore, although specific shapes for various coupling elements have been described above, it will be apparent that the generally rectangular and spherical mounting components could be provided in various other types of shapes. Furthermore, although a specific embodiment in which a groove is provided in a housing of the accessory and a mating rail is provided in the accessory mount is described above, it will be apparent that the groove could be provided in the accessory mount and the rail in the accessory housing.

Additionally, while the accessory is described as including a depression or aperture for mating with a flexible projection in the receiving surface of the accessory mount, it will be apparent that these components could be reversed, and the flexible projection provided in the accessory and depression in the receiving surface of the accessory mount.

Also, although the groove and rail have been described as provided on the sides of the accessory housing and accessory mount, it will be apparent that a groove or rail could be provided on the bottom surface of the accessory, and a mating element provided on the receiving surface of the accessory mount. Similarly, flexible projections and mating depressions can be provided in the sides of the non-contact voltage sensing accessory as well as in the accessory mount. Additionally, although the invention is described above as including either a non-contact voltage sensing accessory or a subsurface object locator, it will be apparent that a drill could be provided with both. Furthermore, the coupling elements, including the key and slot connection described with respect to the subsurface object locator could also be used with a non-contact voltage sensing accessory and the groove and rail connection in the non-contact voltage sensing accessory in a subsurface object locator accessory.

A preferred embodiment of a power tool including an attachment of the invention has been described in particular detail. Many modifications and variations of the embodiment described will be apparent to those skilled in the art. Therefore, the invention is not limited to the embodiment described but should be defined by the claims which follow.

We claim:

1. A power tool, comprising:
a housing including an accessory mount having at least one of a groove and a rail; and
a detachable non-contact voltage sensing accessory, comprising a housing, a non-contact voltage sensing circuit received in the housing, and at least one indicator providing an alarm signal indicating that the power tool is in proximity to a live electrical wire, the non-contact voltage sensing accessory including at least one of a groove and a rail adapted to be coupled to the other of a groove and rail provided in the accessory mount for retaining the accessory in the accessory mount.

2. The power tool of claim 1, wherein the accessory mount includes first and second opposed side walls, and the at least one of rail and groove is formed in each of the first and second side walls.

3. The power tool of claim 1, wherein the accessory mount includes a substantially flat receiving surface for receiving the non-contact voltage sensing accessory, and first and second opposing side walls on opposing sides of the receiving surface, the opposing side walls each including the at least one of a rail and a groove formed in the opposing side walls.

4. The power tool as defined in claim 1, wherein the receiving surface includes an upwardly extending coupling element, and the accessory includes an a depression formed in a lower surface, the depression being sized and dimensioned to receive the upwardly extending coupling element.

5. The power tool as defined in claim 4, wherein the upwardly extending coupling member is coupled to a flexible member formed in the receiving surface.

6. The power tool as defined in claim 1, wherein the accessory mount further includes a front wall provided at a first end of the receiving surface and coupling the opposing side walls, and a shock absorber coupled to the front wall.

7. The power tool as defined in claim 1, wherein the non-contact voltage sensing accessory further comprises a multi-directional switching element, the multi-directional switching element allowing activation from a top side of the accessory and from opposing sides of the accessory.

8. The power tool as defined in claim 1, wherein the non-contact voltage sensing circuit accessory includes an aperture extending through the housing for receipt of an elongate coupling device.

9. The power tool as defined in claim 1, wherein the indicator comprises a light emitting diode and at least one reflector positioned to reflect the light from the light emitting diode onto a translucent portion of the housing.

10. The power tool as defined in claim 1, wherein the non-contact voltage sensing circuit comprises an antenna, and the antenna is located at the end of the tool opposite the tool head.

11. The power tool as defined in claim 1, further comprising a side handle, and wherein an accessory mount is provided in the side handle.

12. The power tool as defined in claim 1, wherein the power tool is at least one of a drill, a reciprocating saw, and a hammer drill.

13. The power tool as defined in claim 1, further comprising an accessory mount for receiving a subsurface object locator.

14. A power tool, comprising:
a housing including an accessory mount including a first coupling element;
a tool head extending from the housing; and
a detachable non-contact voltage sensing accessory, comprising a housing including a second coupling element, a non-contact voltage sensing circuit received in the housing, and at least one indicator providing an alarm signal indicating that the hand tool is in proximity to a live electrical wire, the non-contact voltage sensing accessory including an antenna received in the accessory mount to position the antenna at an end of the power tool opposite the tool head.

15. The power tool as recited in claim 14, wherein the accessory mount is provided in an upper surface of the housing, at a distal end from the tool head.

16. The power tool as recited in claim 14, wherein the accessory mount is provided in a handle formed in the housing, the accessory mount is at a distal end of the handle, and the antenna is provided in the housing at an end furthest from the tool head.

17. The power tool as recited in claim 14, wherein the first coupling element comprises at least one of a rail and a groove, and the second coupling element comprises the other of a rail and a groove.

18. The power tool as recited in claim 14, wherein the accessory mount includes a substantially flat receiving surface for receiving the non-contact voltage sensing accessory, and first and second opposing side walls on opposing sides of the receiving surface, wherein at least one of the first and second side walls includes the first coupling element, and a side of the non-contact voltage sensor housing includes the second coupling element.

19. A tool, comprising:
an accessory mount having at least one of a groove and a rail;
a tool head coupled to the accessory mount; and
a detachable sensing accessory, comprising a housing, a sensing circuit received in the housing, and at least one indicator providing an alarm signal indicating that the sensing circuit has been activated, the sensing accessory including at least one of a groove and a rail adapted to be coupled to the other of a groove and rail provided in the accessory mount for retaining the accessory in the accessory mount.

20. The tool as recited in claim 19, wherein the sensing accessory is at least one of a multi-scanner, a non-contact voltage sensor, and a subsurface object locator.

21. The tool as recited in claim 19, wherein the tool head comprises a power drill.

22. The tool as recited in claim 19, wherein the tool head is at least one of a knife, a pliers, a wire cutter, a wire stripper, a saw, and a screwdriver.

23. The power tool as recited in claim 19, wherein the accessory mount is provided in at least one of a housing and a handle.
